(19) United States
(12) Patent Application Publication
(10) Pub. No.: US 2008/0069546 A1
(43) Pub. Date: Mar. 20, 2008

(54) Information Recording Apparatus and Imaging Device

(76) Inventors: Tsutomu Usui, Tokyo (JP); Nozomu Shimoda, Ninomiya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/853,051

(22) Filed: Sep. 11, 2007

(30) Foreign Application Priority Data
Sep. 12, 2006 (JP) 2006-246254

(51) Int. Cl. H04N 5/00

(52) U.S. Cl. 386/125; 386/E05.001

(57) ABSTRACT

An information recording and reproducing apparatus comprising a portable power source; a recording unit for recording information in a loadable/unloadable recording medium or the built-in recording medium; a dubbing unit for copying and transferring data between the loadable/unloadable recording medium and the built-in recording medium; and a detecting unit for detecting the amount of the remaining energy in the portable power source, wherein the dubbing process between the loadable/unloadable recording medium and the built-in recording medium is allowed when the detecting unit indicates that there is a predetermined amount of energy remaining in the portable power source.

### INCORPORATION BY REFERENCE

The present application claims priority from Japanese application JP2006-246254 filed on Sep. 12, 2006, the content of which is hereby incorporated by reference into this application.

### BACKGROUND OF THE INVENTION

This invention relates to a recording apparatus for recording information in a disk type recording medium which is capable of being recorded repeatedly or only a limited number of times, and more particularly to a recording apparatus especially intended for dubbing information in such a disk type recording medium.

As a related prior art is known the Japanese patent document, JP-A-2003-101926. The “problem to be solved” paragraph of this document reads: “In the finalizing process for a DVD-R or DVD-RW disk, it is necessary, from the standpoint of effective playback by a DVD player, to fill the empty recording area of the disk up to a predetermined extent with data or information when only a small amount of information is preciously recorded in the disk. Time required for the empty recording area to be filled up to the predetermined extent will be sometimes longer than several minutes. Accordingly, there may be caused a problem that such a finalizing process cannot be finished with a battery mounted on a portable apparatus.” It is also described in the document that the apparatus invented to solve such a problem comprises “a portable power source, a recording means for recording information in a loadable/unloadable recording medium, a finalizing means for performing the finalizing process of the recording medium, and a detecting means for detecting the amount of the remaining energy in the portable power source.”

### SUMMARY OF THE INVENTION

The prior art described above, however, does not take into consideration the power supply means for the portable apparatus which includes more than one recording device or such an operation as copying or moving data between the plural recording devices. For example, with a portable apparatus including both DVD and HDD mechanisms, the data recorded in the HDD section can be copied by and transferred to the DVD section, or vice versa. Accordingly, the data originally recorded in the HDD section can be detached from the HDD section so that it may be externally stored or administered.

Such a dubbing process as mentioned above may take more than several minutes and therefore a problem will be caused that a battery installed in the portable apparatus could not complete the dubbing process.

It is therefore required to solve such a problem. It is accordingly required to be able to copy the information stored in the HDD or the memory using non-disk type recording medium, both the HDD and the memory being provided in a portable recording apparatus, by means of the DVD or to transfer the information stored in the HDD or the memory to a DVD or a BD (Blu-ray Disc) by using a battery installed in the portable recording apparatus. It is further required to copy or transfer the information in the reverse direction by using such a battery.

The object of this invention is to improve the performance of the information recording apparatus.

This object of the invention will be attained with the inventions claimed in the following claim section of this specification.

Concretely, the object of this invention is to provide an information recording apparatus comprising a portable power source; a recording unit for recording information in the loadable/unloadable recording medium and the built-in recording medium; a dubbing unit for copying and transferring data between the loadable/unloadable recording medium and the built-in recording medium; and a detecting unit for detecting the amount of the remaining energy in the portable power source, wherein the dubbing process between the loadable/unloadable recording medium and the built-in recording medium is allowed when the detecting unit indicates that there is a predetermined amount of energy remaining in the portable power source.

According to this invention, the performance of the information recording apparatus can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 shows in block diagram the structure of an information recording apparatus according to this invention;

FIG. 2 is a flow chart for a process according to a first embodiment of this invention;

FIG. 3 shows an example of a display made by an LCD used in the information recording apparatus according to this invention;

FIG. 4 is a flow chart for a process according to a second embodiment of this invention;

FIG. 5 is a flow chart for a process according to a third embodiment of this invention;

FIG. 6 is a flow chart for a process according to a fourth embodiment of this invention;

FIG. 7 is a flow chart for a process according to a fifth embodiment of this invention; and

FIG. 8 is a flow chart for a process according to a sixth embodiment of this invention.

### DETAILED DESCRIPTION OF THE INVENTION

This invention will now be described by way of preferred embodiments with reference to the attached drawings.

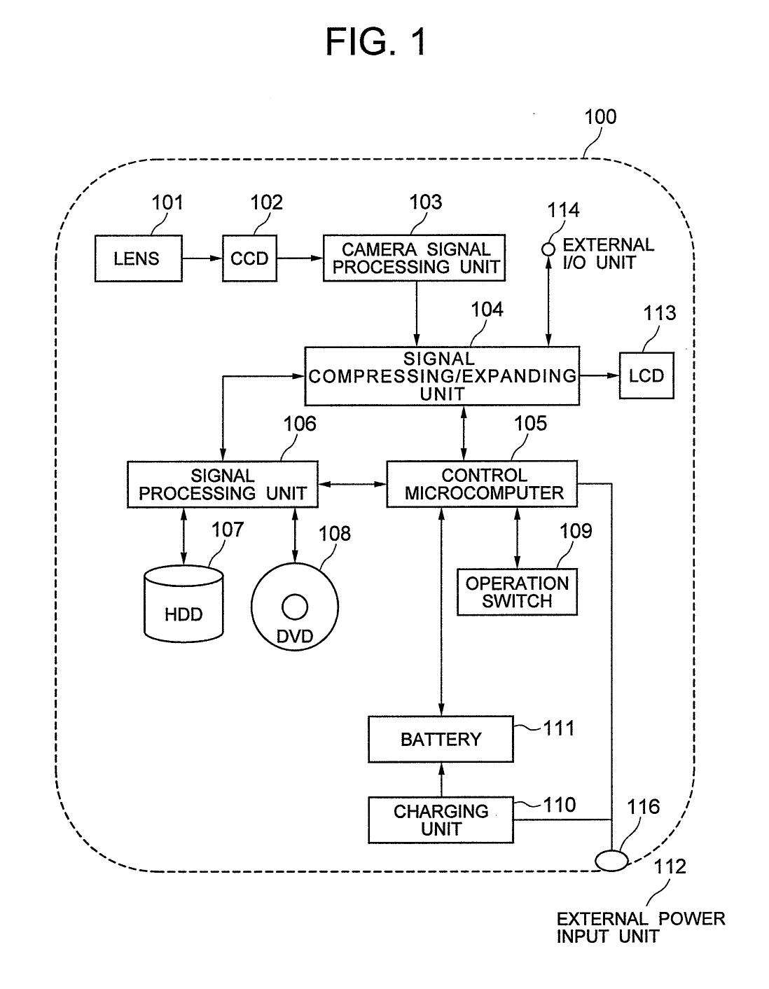

FIG. 1 shows in block diagram the structure of a camera as an embodiment of an information recording/reproducing apparatus (information recording apparatus) 100 according to this invention.

In FIG. 1 are shown a lens 101; an imaging sensor 102 such as CCD; a camera signal processing unit 103; a signal compressing/expanding unit 104; a control microcomputer 105; a signal processing unit 106; a hard disk drive (HDD) 107; a digital versatile disk (DVD) device 108; an operation switch 109; a charging unit 110; a battery 111; an external power input unit 112; a liquid crystal display (LCD) 113; and an external I/O unit (I/F) 114.

The operation of the information recording apparatus 100 shown in FIG. 1 will be described first. The image of an object is captured through the lens 101 by the CCD 102. The image captured by the CCD 102 is then transduced into a corresponding electric signal and the electric signal is converted to a picture signal by the camera signal processing unit 103.

The thus produced picture signal is then converted to a digital picture signal by the signal compressing/expanding unit 104 that is controlled by the control microcomputer 105. It is also possible to convert an externally supplied picture signal to the corresponding digital picture signal by selecting the input from the external I/O unit (I/F) 114.

The digital picture signal thus obtained is then recorded through the signal processing unit 106 in the external storage device such as the HDD 107 or the DVD 108.

The actuation of the operation switch 109 controls the microcomputer 105 to cause the signal processing unit 106 to read out the picture signal recorded in the DVD and to write the read picture signal into the HDD, thereby effecting a dubbing process between the two different data media. It is also possible to read out the picture signal recorded in the HDD and to write the read picture signal into the DVD.

It is further possible to output the signal recorded in the storage device to the above mentioned I/O terminal after being expanded by the signal compressing/expanding unit 104. It is also possible to display the signal recorded in the storage device on the LCD 113. The LCD 113 may be replaced by an organic EL display.

The information recording apparatus 100 shown in FIG. 1 has the external power input unit 112 as a power supply and the unit 112 enables power to be supplied externally, e.g. from the commercial AC power line. Further, when the external power input unit 112 supplies power to the information recording apparatus 100 through an external power input terminal 116, it enables the charging unit 110 to charge the battery 111. While the external power input unit 112 is supplying power to the information recording apparatus 100, the components of the apparatus 100 are energized by the external power input unit. When the external power input unit 112 does not supply power to the information recording apparatus 100, the components of the apparatus 100 can be energized by the battery 111. It is not necessary to provide the entire function essential for charging the battery within the apparatus 100. A part or the whole part of the function may be provided outside the external power input unit 112.

The control microcomputer 105 can obtain the amount of the remaining energy in the battery and select the external power source. This function of the control microcomputer 105 may also be performed by the charging unit 110.

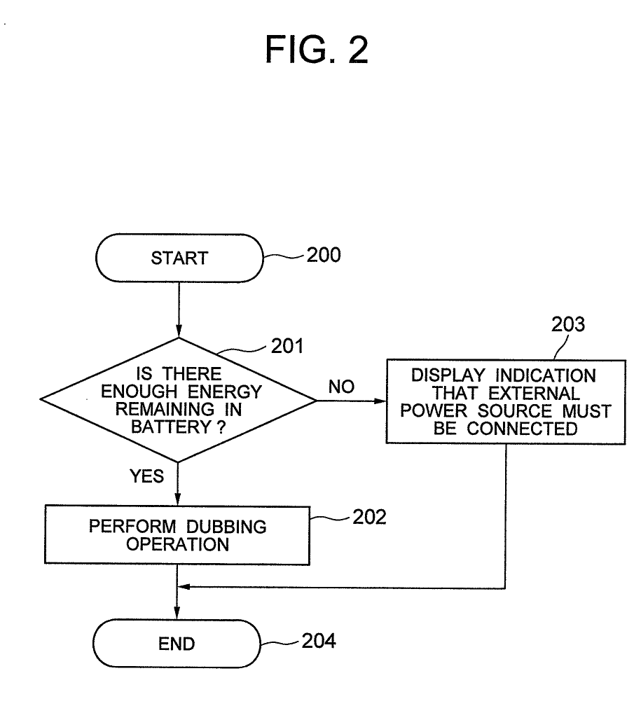

The first embodiment of this invention will now be described with reference to FIG. 2. With this information recording apparatus 100, when a dubbing process is performed by actuating the operation switch 109, the amount of the remaining energy of the battery is first checked in step 201. If the result of checking assures that there is an enough amount of the remaining energy in the battery, the dubbing process is performed as indicated in step 202. On the other hand, if the result of checking is that the remaining amount is not enough to complete the dubbing process, the indication that the external power source must be connected is displayed as indicated in step 203.

This flow chart shown in FIG. 2 is for a dubbing process (i.e. copy of data) but the operation represented by this flow chart can equally be applied to a move process (i.e. transfer of data).

The detection of the amount of remaining energy in the battery uses the voltage developed, for example, across the terminals of the battery. As the battery continues to discharge, the terminal voltage gradually falls. Therefore, the terminal voltage of the battery is indicative of the amount of the remaining energy in the battery and can be used to detect the amount. Of course, any other suitable method may be used for the purpose.

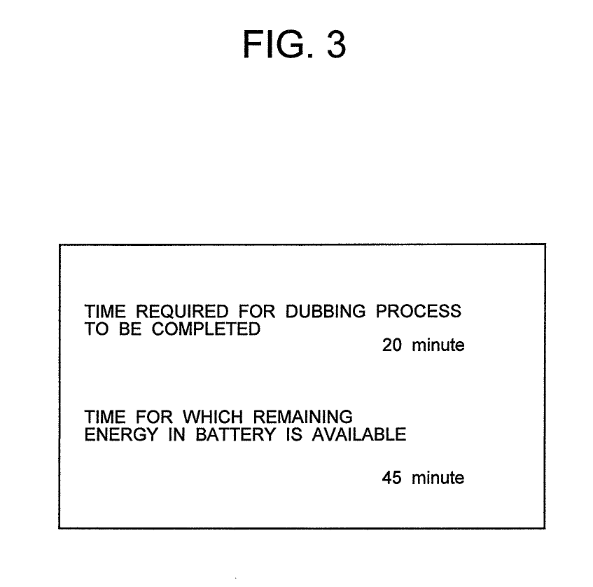

As shown in FIG. 3, when the dubbing process is initiated, the amount of the remaining energy in the battery and the time required for completing the dubbing process are both displayed on the LCD to tell the user that there is enough energy left in the battery. The remaining time required for completing the ongoing dubbing process can be displayed by continuously counting down from the full dubbing time and displaying the instantaneous value of count down during the dubbing process.

The amount of the remaining energy in the battery can be represented, for example, numerically in terms of time or may also be indicated graphically in the form of a bar shrinking in length with time, with a time graduation alongside.

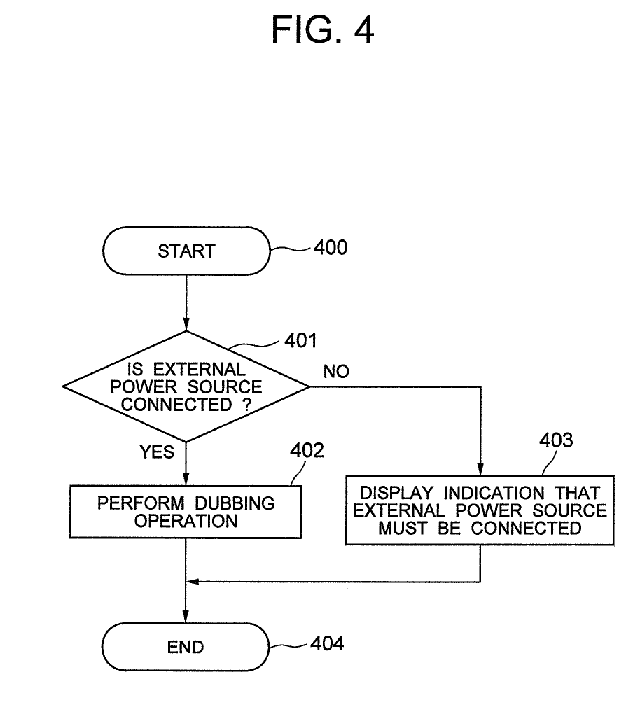

The second embodiment of this invention will now be described with reference to FIG. 4. When a dubbing process is initiated by actuating the operation switch 109 as in the first embodiment described above, decision is made on whether or not the external power source is connected with the information recording apparatus 100, in step 401 in FIG. 4. When the external power source is connected with the information recording apparatus 100, the dubbing process is performed in step 402. When the external power source is not connected, the indication that the external power source must be connected is displayed.

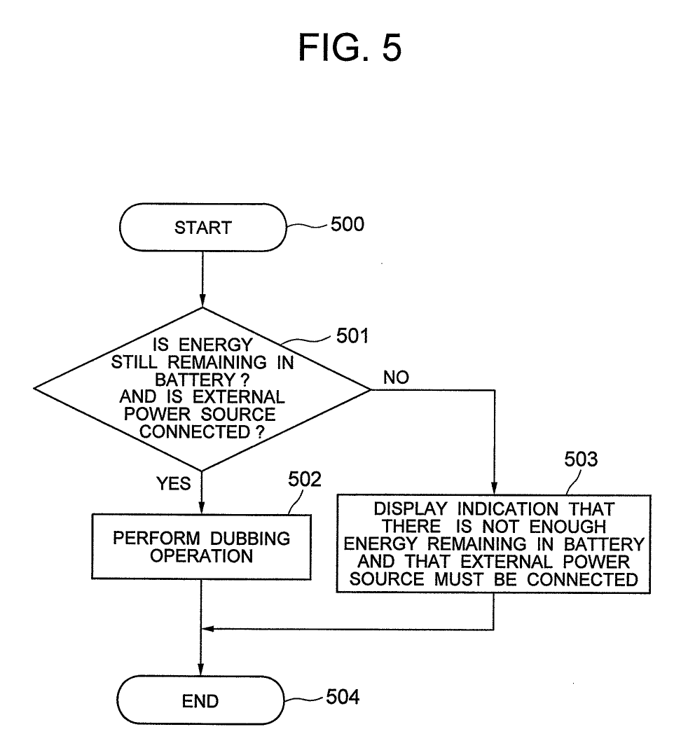

The third embodiment of this invention will be described below with reference to FIG. 5. When a dubbing process is initiated by actuating the operation switch 109 as in the first embodiment described above, decision is made on whether there is enough energy still remaining in the battery and whether or not the external power source is connected with the information recording apparatus 100, in step 501 in FIG. 5. When there is enough energy still remaining in the battery and when the external power source is connected with the information recording apparatus 100, the dubbing process is performed in step 502. When there is not enough energy remaining in the battery and when the external power source is not connected, the indication that there is not enough energy and that the external power source must be connected, is displayed.

According to this embodiment, since the dubbing process is initiated only when power can be supplied to the information recording apparatus 100 from both the battery 111 and the external power source, the dubbing process can be securely continued even when one of both the power supplying sources becomes unable to supply power.

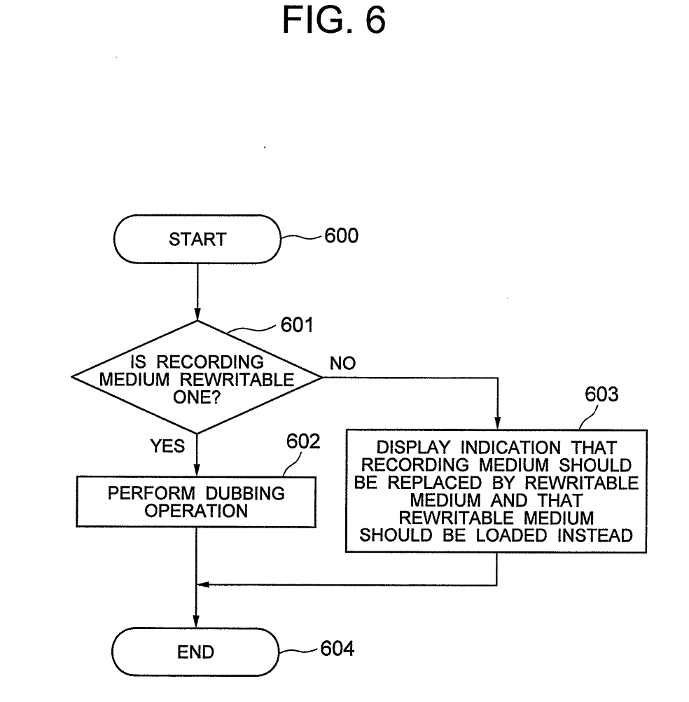

The fourth embodiment of this invention will be described below with reference to FIG. 6. When a dubbing process is initiated by actuating the operation switch 109 as in the first embodiment described above, decision is made on whether the recording medium for dubbing data in is a rewritable medium such as DVD-RW, DVD+RW or DVD-RAM, in step 601 in FIG. 6. When the recording medium for dubbing data in is a rewritable medium, the dubbing process is performed in step 602. When the recording medium is not a rewritable medium, the indication that the recording medium should be replaced by a rewritable medium and that the rewritable medium should be loaded instead, is displayed in 603.

According to this embodiment, if the dubbing process should fail, that is, be stopped midway, owing to the shortage of the remaining energy in the battery occurring during the ongoing dubbing process, the dubbing process can be resumed since the used recording medium permits rewriting.

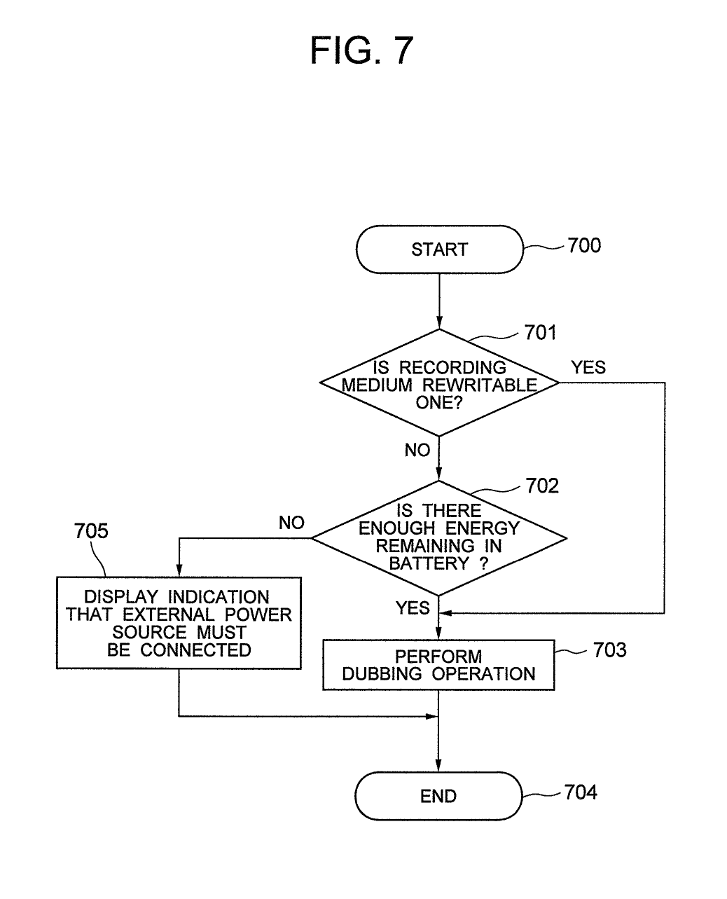

The fifth embodiment of this invention will be described below with reference to FIG. 7. When a dubbing process is initiated by actuating the operation switch 109 as in the first embodiment described above, decision is made on whether the recording medium for dubbing data in is a rewritable medium such as DVD-RW, DVD+RW or DVD-RAM, in step 701 in FIG. 7. When the recording medium is not a rewritable medium, the amount of the remaining energy in the battery is checked in step 702. If the remaining energy is deemed to be enough to complete the dubbing process, the dubbing process is initiated in 703. If, on the other hand, the remaining energy is deemed to be not enough to complete the dubbing process, the indication that the external power source must be connected, is displayed in step 705 as in step 203.

When the recording medium is a rewritable medium, the dubbing process is initiated in step 703.

According to this embodiment, the dubbing process is initiated only after securing that the remaining energy in the battery is enough to complete the dubbing process, if the loaded recording medium is a once-for-all rewritable medium such as a DVD-R disk. Therefore, the dubbing process can be prevented from failing due to the shortage of battery energy occurring during the dubbing process. Thus, even a non-rewritable medium can be safely subjected to a dubbing process.

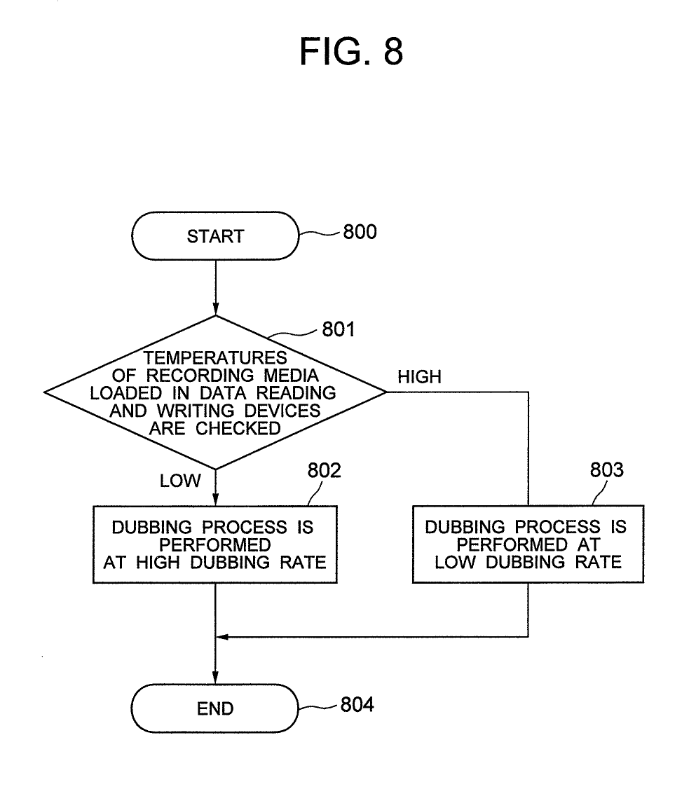

The sixth embodiment of this invention will be described below with reference to FIG. 8. When a dubbing process is initiated by actuating the operation switch 109 as in the first embodiment described above, the temperatures of the recording media loaded in the data reading device, e.g. DVD or HDD, and the data writing device, e.g. HDD or DVD, are first checked in step 801 in FIG. 8. And decision is made on whether the temperatures of the devices to be reached during the dubbing process can be suppressed below the preset temperature, on the basis of the temperatures of the devices reached before the initiation of the dubbing process. Thus, the dubbing process is performed at a high or a low dubbing rate according as the temperatures to be reached during the dubbing process are deemed lower or higher than the preset value, respectively.

The plural embodiments of this invention have been individually described in the foregoing. However, any combination of these embodiments can be employed to attain the object of this invention.

In the above description, DVDs are taken as examples but it is noted here that this invention can be applied to any similar optical disks such as BDs and HD-DVDs, and even to a combination of an HDD and a semiconductor memory and a combination of a build-in semiconductor memory and a removable semiconductor memory. The application of this invention to a combination of an HDD and an optical disk is especially advantageous since such a combination requires a relatively large power consumption.

It should be further understood by those skilled in the art that although the foregoing description has been made on embodiments of the invention, the invention is not limited thereto and various changes and modifications may be made without departing from the spirit of the invention and the scope of the appended claims.

1. An information recording apparatus comprising a portable power source; a recording means for recording information in a loadable/unloadable recording medium and a built-in recording medium; a dubbing means for copying and transferring data between the loadable/unloadable recording medium and the built-in recording medium; and a detecting means for detecting the amount of the remaining energy in the portable power source, wherein the dubbing process between the loadable/unloadable recording medium and the built-in recording medium is allowed when the detecting means indicates that there is a predetermined amount of energy remaining in the portable power source.

2. An information recording apparatus comprising a portable power source; a detecting means for detecting the amount of the remaining energy in the portable power source; a dubbing means for copying and transferring data between plural recording media; and a display means for displaying the result detected by the detecting means and the time required for the dubbing means to complete the dubbing or move process and estimated on the basis of the recordable areas of the recording media.

3. An information recording apparatus comprising a first power source that is portable; an external power terminal to be connected with a second power source provided externally; a dubbing means for copying and transferring data between plural recording media; and a checking means for checking whether the power from the second power source is supplied to the external power terminal, wherein the plural recording media can be subjected to dubbing process when the power from the second power source is supplied to the external power terminal.

4. An information recording apparatus according to claim 3, wherein the plural recording media can not be subjected to dubbing process when the power from the second power source is not supplied to the external power terminal.

5. An information recording apparatus comprising a first power source that is portable; an external power terminal to be connected with a second power source provided externally; a dubbing means for copying and transferring data between plural recording media; a first detecting means for detecting the amount of the remaining energy in the first power source; and a second detecting means for detecting the power being supplied to the external power terminal from the second power source, wherein the plural recording media can be subjected to dubbing process when the first and second detecting means detect the first and second power sources being ready to supply power.

6. An information recording apparatus according to claim 1, wherein the recording media can be subjected to dubbing process when the loadable/unloadable recording medium is a non-rewritable recording medium and when the detecting means detects the portable power source having the amount of the remaining energy of a predetermined value.

7. An imaging apparatus comprising a lens unit; an imaging means for obtaining an electric signal from a photo-signal obtained through the lens unit; a signal processing means for converting the signal obtained by the imaging means to a picture signal; a signal compressing/expanding means for converting the picture signal to a corresponding digital signal; a recording means for recording the image information outputted from the imaging means in a loadable/unloadable recording medium or the built-in recording medium; a control microcomputer for controlling the second signal processing means or the signal compressing/expanding means; an operation switch for inputting information into the control microcomputer depending on the user's manipulation; a battery for energizing various means and devices; a charging device for charging the battery; an external power input means for supplying power to the charging device; an external I/O means for inputting and outputting the picture signal; and a dubbing means for performing a dubbing process or transferring process between plural recording media, wherein the information input by the actuation of the operation switch is prohibited while the dubbing process or the transferring process is in progress by the dubbing means.

8. An information recording apparatus according to claim 7, further comprising: a display device; and a switching means for selectively choosing plural levels of power consumed by the display device; wherein the switching means lowers the level of the power consumed by the display device while the dubbing or moving process is in progress by the dubbing means.

9. An information recording apparatus according to claim 7, further comprising a detecting means for detecting the amount of the remaining energy in the portable power source, wherein the dubbing process for the recording media is stopped when the detecting means detects the power level of the portable power source falling below a predetermined level while the dubbing or moving process is in progress by the dubbing means.

10. An information recording apparatus according to claim 7, comprising a temperature measuring means for measuring the temperatures of the recording media, wherein the data transfer rate in the dubbing or moving process performed between the recording media by the dubbing means is increased when the temperature measuring means detects the temperatures of the recording media not exceeding a predetermined value while the dubbing or moving process is in progress by the dubbing means.

11. An information recording apparatus according to claim 7, comprising a temperature measuring means for measuring the temperatures of the recording media, wherein the data transfer rate in the dubbing or moving process performed between the recording media by the dubbing means is decreased when the temperature measuring means detects the temperatures of the recording media exceeding a predetermined value while the dubbing or moving process is in progress by the dubbing means.
